(19) United States
(12) Patent Application Publication
(10) Pub. No.: US 2026/0277959 A1
(43) Pub. Date: Sep. 17, 2026

(54) CONTENT GENERATION METHOD AND APPARATUS BASED ON LARGE MODEL, ELECTRONIC DEVICE, AND MEDIUM

(71) Applicant: BAIDU.COM TIMES TECHNOLOGY (BEIJING) CO., LTD., BEIJING (CN)

(72) Inventors: Yuchen LI, BEIJING (CN); Jiamin CHEN, BEIJING (CN); Linghe KONG, BEIJING (CN); Chen MA, BEIJING (CN); Xinyu MA, BEIJING (CN); Hengyi CAI, BEIJING (CN); Daiting SHI, BEIJING (CN); Shuaiqiang WANG, BEIJING (CN); Dawei YIN, BEIJING (CN)

(73) Assignee: BAIDU.COM TIMES TECHNOLOGY (BEIJING) CO., LTD., BEIJING (CN)

(21) Appl. No.: 19/679,419

(22) Filed: May 15, 2026

(30) Foreign Application Priority Data
Nov. 26, 2025 (CN) 202511757638.4

(51) Int. Cl. G06F 16/3329

(52) U.S. Cl. CPC G06F 16/33295

(57) ABSTRACT

A method includes: obtaining a first query instruction and a first text segment; performing a first operation to determine a target connector for replacing a connector in the first text segment; and generating reply content for replying to the first query instruction, by using the large language model and based on the first text segment after replacement with the target connector and the first query instruction. The first operation includes: obtaining a second query instruction and a second text segment obtained through retrieval; obtaining a plurality of candidate formatted text segments by replacing connectors in the second text segment based on each of a plurality of candidate connectors; and determining, from the plurality of candidate connectors by using the large language model and based on the plurality of candidate formatted text segments, the target connector.

### CROSS REFERENCE TO RELATED APPLICATION

This application claims priority to Chinese patent application No. 202511757638.4 filed on Nov. 26, 2025, the contents of which are hereby incorporated by reference in their entirety for all purposes.

### TECHNICAL FIELD

The present disclosure relates to the field of artificial intelligence, in particular, to the field of large language models, intelligent agents, and content generation technologies, and specifically to a content generation method and apparatus based on a large model, an electronic device, a computer-readable storage medium, and a computer program product.

### BACKGROUND

Artificial intelligence is a subject on making a computer simulate some thinking processes and intelligent behaviors (such as learning, reasoning, thinking, and planning) of a human, and involves both hardware-level technologies and software-level technologies. Artificial intelligence hardware technologies generally include technologies such as sensors, dedicated artificial intelligence chips, cloud computing, distributed storage, and big data processing. Artificial intelligence software technologies mainly include the following several general directions: computer vision technologies, speech recognition technologies, natural language processing technologies, machine learning/deep learning, big data processing technologies, and knowledge graph technologies.

Human-computer interaction is a manner in which humans interact with machines by using natural language. With the continuous development of artificial intelligence technologies, machines have been enabled to understand information output by humans, comprehend the intrinsic meaning of the information, and provide corresponding feedback. In these operations, the accuracy of semantic understanding, the speed of feedback, and the provision of corresponding opinions or suggestions all become factors affecting the smoothness of human-computer interaction.

Methods described in this section are not necessarily methods that have been previously conceived or employed. It should not be assumed that any of the methods described in this section is considered to be prior art just because they are included in this section, unless otherwise indicated expressly. Similarly, the problem mentioned in this section should not be considered to be universally recognized in any prior art, unless otherwise indicated expressly.

### SUMMARY

The present disclosure provides a content generation method and apparatus based on a large model, an electronic device, a computer-readable storage medium, and a computer program product.

According to an aspect of the present disclosure, a content generation method based on a large model is provided. The method includes: obtaining a first query instruction and a first text segment obtained through retrieval based on the first query instruction; performing a first operation to determine a target connector for replacing a connector used for connecting two adjacent words in the first text segment, the first operation including: obtaining a second query instruction and a second text segment obtained through retrieval based on the second query instruction, where the corresponding text segment is used for generating reply content for replying to the corresponding query instruction; determining a plurality of candidate connectors, where each candidate connector is used for replacing a connector between two adjacent words in the second text segment; obtaining a plurality of candidate formatted text segments in one-to-one correspondence with the plurality of candidate connectors by replacing at least a part of connectors in the second text segment based on the plurality of candidate connectors; and determining, from the plurality of candidate connectors by using the large language model and based on the plurality of candidate formatted text segments, the target connector, a target connector corresponding to a candidate formatted text segment that enables optimal reply content to be generated; and generating reply content for replying to the first query instruction, by using the large language model and based on the first text segment after replacement with the target connector and the first query instruction.

According to still another aspect of the present disclosure, an electronic device is provided. The electronic device includes: a memory storing one or more programs configured to be executed by one or more processors, the one or more programs including instructions for performing operations comprising: obtaining a first query instruction and a first text segment obtained through retrieval based on the first query instruction; performing a first operation to determine a target connector for replacing a connector used for connecting two adjacent words in the first text segment, the first operation comprising: obtaining a second query instruction and a second text segment obtained through retrieval based on the second query instruction, wherein the first text segment is used for generating reply content for replying to the first query instruction and the second text segment is used for generating reply content for replying to the second query instruction; determining a plurality of candidate connectors, wherein each candidate connector is used for replacing a connector between two adjacent words in the second text segment; obtaining a plurality of candidate formatted text segments in one-to-one correspondence with the plurality of candidate connectors by replacing at least a part of connectors in the second text segment based on the plurality of candidate connectors; and determining, from the plurality of candidate connectors by using the large language model and based on the plurality of candidate formatted text segments, the target connector, a target connector corresponding to a candidate formatted text segment that enables optimal reply content to be generated; and generating reply content for replying to the first query instruction, by using the large language model and based on the first text segment after replacement with the target connector and the first query instruction.

According to another aspect of the present disclosure, a non-transitory computer-readable storage medium storing computer instructions is provided, wherein the computer instructions are used to enable the computer to perform the following operations: obtaining a first query instruction and a first text segment obtained through retrieval based on the first query instruction; performing a first operation to determine a target connector for replacing a connector used for connecting two adjacent words in the first text segment, the first operation comprising: obtaining a second query instruction and a second text segment obtained through retrieval based on the second query instruction, wherein the first text segment is used for generating reply content for replying to the first query instruction and the second text segment is used for generating reply content for replying to the second query instruction; determining a plurality of candidate connectors, wherein each candidate connector is used for replacing a connector between two adjacent words in the second text segment; obtaining a plurality of candidate formatted text segments in one-to-one correspondence with the plurality of candidate connectors by replacing at least a part of connectors in the second text segment based on the plurality of candidate connectors; and determining, from the plurality of candidate connectors by using the large language model and based on the plurality of candidate formatted text segments, the target connector, a target connector corresponding to a candidate formatted text segment that enables optimal reply content to be generated; and generating reply content for replying to the first query instruction, by using the large language model and based on the first text segment after replacement with the target connector and the first query instruction.

It should be understood that the content described in this section is not intended to identify critical or important features of the embodiments of the present disclosure, and is not intended to limit the scope of the present disclosure. Other features of the present disclosure will be readily understood with reference to the following description.

### BRIEF DESCRIPTIONS OF THE DRAWINGS

The accompanying drawings show example embodiments and form a part of the specification, and are used to explain example implementations of the embodiments together with the written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein can be implemented according to an embodiment of the present disclosure;

FIG. 2 is a flowchart of a content generation method based on a large model according to an embodiment of the present disclosure;

FIG. 3 is a schematic diagram of a content generation method based on a large model according to an embodiment of the present disclosure;

FIG. 4 is a structural block diagram of a content generation apparatus based on a large model according to an embodiment of the present disclosure; and

FIG. 5 is a structural block diagram of an example electronic device that can be used to implement an embodiment of the present disclosure.

### DETAILED DESCRIPTION OF THE EMBODIMENTS

Example embodiments of the present disclosure are described below in conjunction with the accompanying drawings, where various details of the embodiments of the present disclosure are included to facilitate understanding, and should only be considered as exemplary. Therefore, those of ordinary skill in the art should be aware that various changes and modifications can be made to the embodiments described here, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of the listed terms.

The embodiments of the present disclosure will be described below in detail with reference to the accompanying drawings.

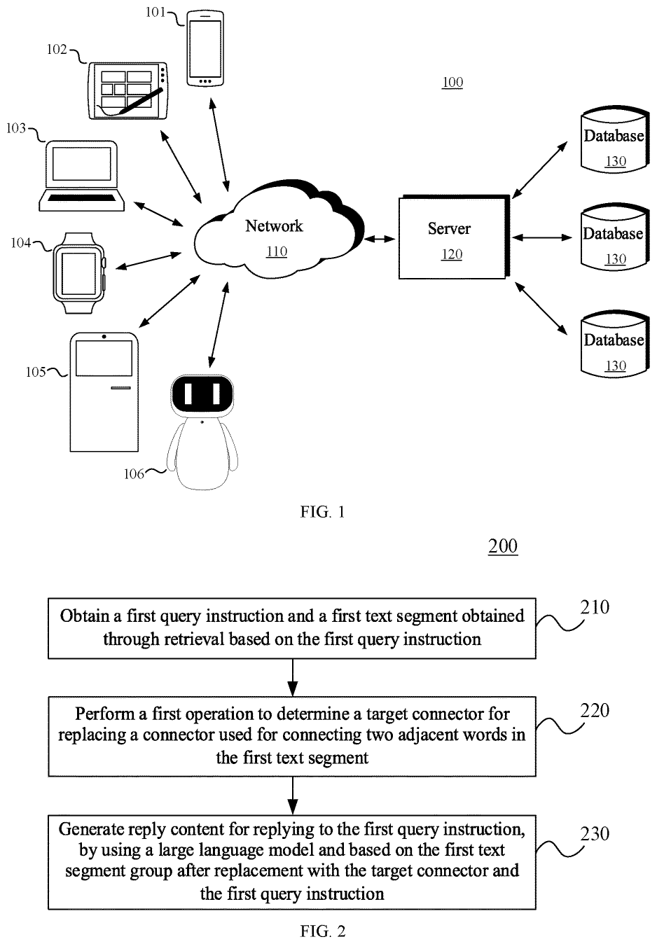

FIG. 1 is a schematic diagram of an example system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communication networks 110 that couple the one or more client devices to the server 120. The client devices 101, 102, 103, 104, 105, and 106 may be configured to execute one or more applications.

In an embodiment of the present disclosure, the server 120 can run one or more services or software applications that enable a content generation method based on a large model to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software-as-a-service (SaaS) model.

In the configuration shown in FIG. 1, the server 120 may include one or more components that implement functions performed by the server 120. These components may include software components, hardware components, or a combination thereof that can be executed by one or more processors. The user operating the client devices 101, 102, 103, 104, 105, and/or 106 may sequentially use one or more client applications to interact with the server 120, to use the services provided by these components. It should be understood that various different system configurations are possible, and may be different from that of the system 100. Therefore, FIG. 1 is an example of the system for implementing various methods described herein, and is not intended to be limiting.

The user may use the client devices 101, 102, 103, 104, 105, and/or 106 to enter query instructions, obtain reply content, etc. The client device may provide an interface that enables the user of the client device to interact with the client device. The client device may further output information to the user via the interface. Although FIG. 1 shows only six client devices, those skilled in the art will understand that any number of client devices are supported in the present disclosure.

The client devices 101, 102, 103, 104, 105, and/or 106 may include various types of computer devices, such as a portable handheld device, a general-purpose computer (such as a personal computer and a laptop computer), a workstation computer, a wearable device, a smart screen device, a self-service terminal device, a service robot, a gaming system, a thin client, various messaging devices, and a sensor or other sensing devices. These computer devices can run various types and versions of software applications and operating systems, such as MICROSOFT Windows, APPLE IOS, a UNIX-like operating system, and a Linux or Linux-like operating system (e.g., GOOGLE Chrome OS), or include various mobile operating systems, such as MICROSOFT

Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet-related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (such as Bluetooth or Wi-Fi), and/or any combination of these and/or other networks.

The server 120 may include one or more general-purpose computers, a dedicated server computer (for example, a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any one of the above-mentioned operating systems and any commercially available server operating system. The server 120 can also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and 106. The server 120 may further include one or more applications to display the data feeds and/or real-time events via one or more display devices of the client devices 101, 102, 103, 104, 105, and 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be used to store information such as candidate connectors and determined target connectors. The databases 130 may reside in various positions. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases can store, update, and retrieve data from or to the database, in response to a command.

In some embodiments, one or more of the databases 130 may further be used by an application to store application data. The database used by the application may be of different types, for example, may be a key-value repository, an object repository, or a regular repository backed by a file system.

The system 100 of FIG. 1 may be configured and operated in various manners, so that the various methods and apparatuses described according to the present disclosure can be applied.

Currently, large language models (LLMs) have been widely used in a retrieval-augmented generation (RAG) framework for tasks such as long-form question answering, document summarization, and fact-checking. In the present disclosure, retrieval-augmented generation (RAG) refers to introducing external knowledge retrieval in a generation process of a large language model (LLM) to improve the accuracy and reliability of reply content. By allowing the LLM to refer to information from an external knowledge base before generating answers, the RAG technology can effectively reduce factual errors (that is, so-called “hallucinations”) produced by the model and enhance the factual correctness of the answers. Current RAG systems generally focus only on the relevance between retrieved content itself and a query instruction (e.g., a user-input question, that is, the “key”), neglecting the critical issue of “how to represent” the retrieved content (that is, the “value”).

Besides known issues of retrieval quality and contextual order, research has found that a critical influencing factor is commonly overlooked: The representation format (context format) of the retrieved content may significantly affect the comprehension effectiveness and generation quality of the model. For example, even if the semantics of retrieved text segments are completely identical, merely due to subtle differences in format (such as using different delimiters between a key and a value or using different structural markers between the text segments), the generation results of the LLM can exhibit significant variations. In long-context scenarios, this format sensitivity is particularly prominent, often leading to issues such as accuracy fluctuations and incoherent answer logic.

Currently, most RAG systems default to using fixed templates (such as plain text or JSON-like structures) to organize inputs, without considering the differences in adaptability of different models to formats, nor having mechanisms to dynamically select the representation most suitable for a current model. This “format selection blind spot” limits the full utilization of the contextual comprehension capabilities of the model. Moreover, due to the lack of discernible patterns in the sensitivity of the model to formats, manually designed templates are often effective for one specific model but yield inconsistent results across different architectures and tasks, lacking transferability and universality. This leads to high tuning costs and poor reliability during system construction and deployment.

Therefore, there is an urgent need for an automated, model-adaptive context format optimization method that can perform normalization processing on input formats without altering original semantics, thereby enhancing the robustness and reasoning capability of long-context RAG.

Accordingly, according to an embodiment of the present disclosure, a content generation method based on a large model is provided. FIG. 2 is a flowchart of a content generation method based on a large model according to an embodiment of the present disclosure. As shown in FIG. 2, the method 200 includes: obtaining a first query instruction and a first text segment obtained through retrieval based on the first query instruction (step 210); performing a first operation to determine a target connector for replacing a connector used for connecting two adjacent words in the first text segment (step 220), the first operation including: obtaining a second query instruction and a second text segment obtained through retrieval based on the second query instruction, where the corresponding text segment is used for generating reply content for replying to the corresponding query instruction; determining a plurality of candidate connectors, where each candidate connector is used for replacing a connector for connecting two adjacent words in the second text segment; obtaining a plurality of candidate formatted text segments in one-to-one correspondence with the plurality of candidate connectors by replacing at least a part of connectors in the second text segment based on the plurality of candidate connectors; and determining, from the plurality of candidate connectors by using the large language model and based on the plurality of candidate formatted text segments, the target connector, a target connector corresponding to a candidate formatted text segment that enables optimal reply content to be generated; and generating reply content for replying to the first query instruction, by using the large language model and based on the first text segment after replacement with the target connector and the first query instruction (step 230).

According to the embodiments of the present disclosure, without relying on model training or modifying the model structure, normalization processing is performed, using corresponding connectors, on the data format input to the model while maintaining the original semantics, thereby reducing the model's sensitivity to the structure of retrieved content and enhancing the model's capability to integrate heterogeneous text segments.

In some embodiments, the first query instruction and the second query instruction may be the same or different. Further, the first text segment and the second text segment may also be the same or different. That is, the first query instruction may be directly used as the second query instruction, and the first text segment may be directly used as the second text segment. The first query instruction is a pending query instruction.

In some embodiments, when the first query instruction and the second query instruction are different, the quantity of input tokens (or referred to as an input token sequence) determined based on a data group formed by the first query instruction and the first text segment is approximately the same as the quantity of input tokens determined based on a data group formed by the second query instruction and the second text segment.

In some embodiments, an input token is the smallest text unit (or a basic data unit, or the smallest semantic unit) input to the large language model (LLM). Although a token is the smallest unit in text processing processes, it is not specifically limited to a word; instead, it may be a word, a letter, a number, a punctuation mark, etc. For example, according to the existing conventions, one token is approximately equal to 1 to 1.8 Chinese characters; and in English text, one token is approximately equal to 3 to 4 letters. During content generation based on a large language model, an input text is required to be converted into individual tokens first, then, based on the comprehension and analysis of information about the tokens in the context, token content that should be generated next is predicted, and the generated tokens are converted into output text content that humans are familiar with. For example, for the above-mentioned embodiment, the candidate formatted text segment and the corresponding query instruction input to the large language model are converted into corresponding input tokens, for analysis and processing by the large language model to predict corresponding output tokens, which are converted into corresponding reply content to be fed back to the user.

In some embodiments, the first text segment and the second text segment may include at least one text segment, which is not limited herein.

In the embodiments according to the present disclosure, a corresponding text segment for replying to a corresponding query instruction may be obtained based on the query instruction in any suitable manner, which is not limited herein. For example, in a RAG system, during a query, the system first encodes a user query instruction into a vector representation using an embedding model, then retrieves document fragments most relevant to the query from a vector database, fills these fragments into a pre-designed prompt template, and provides them together to the LLM (that is, the large language model) to generate a final answer.

In some embodiments, the obtained corresponding text segment may be a text segment after data preprocessing. Data preprocessing is a process of converting various raw data into a structured format suitable for use in the LLM. For example, through data cleaning and normalization, noise and irrelevant information are removed. Alternatively, document partitioning may be performed, that is, dividing the content into logical units based on the natural structure (chapters, paragraphs, tables, etc.) of a document.

In some embodiments, each candidate connector is used for replacing a connector between two adjacent words in the second text segment. For example, in a sentence of text “The Great Migration in Africa is one of the most spectacular wildlife phenomena in the world”, two adjacent words are connected by a space connector “ ”. After replacing the space connector in this sentence with a hyphen connector “−”, the sentence becomes “The-Great-Migration-in-Africa-is-one-of-the-most-spectacular-wildlife-phenomena-in-the-world”.

Therefore, in some embodiments, the obtained text segment may be chunked into a plurality of sentences through, for example, a document chunking technology. The document chunking technology balances the contextual completeness of retrieved content and the granularity of fragments by dividing a long document into smaller semantic paragraphs or text chunks. Reasonable chunking allows a vector search to have sufficient context to determine relevance without affecting match accuracy due to overly long paragraphs. In this case, the obtained text segment may be one that has already been chunked into a plurality of sentences. Then, a connector between each two adjacent words in a corresponding sentence can be replaced to obtain the candidate formatted text segment.

In some embodiments, the plurality of candidate formatted text segments in one-to-one correspondence with the plurality of candidate connectors are obtained by replacing at least a part of connectors in the second text segment based on the plurality of candidate connectors; and the target connector that enables the optimal reply content to be generated is determined from the plurality of candidate connectors by using the large language model and based on the plurality of candidate formatted text segments.

Specifically, when the second text segment is the above-mentioned sentence of text, and the plurality of determined candidate connectors include a hyphen connector “−” and a connector “&” representing “and”, the space connector “ ” in this sentence is separately replaced with the connectors “−” and “&”, to obtain a candidate formatted text segment 1 “The-Great-Migration-in-Africa-is-one-of-the-most-spectacular-wildlife-phenomena-in-the-world” and a candidate formatted text segment 2 “The&Great&Migration&in&Africa&is&one&of&the&most&spectacular&wildlife&phenomen a&in&the&world”. Then, the candidate formatted text segment 1 and the corresponding second query instruction can be input together into the large language model to obtain reply content; and the candidate formatted text segment 2 and the corresponding second query instruction can also be input together into the large language model to obtain reply content. If it can be determined that the reply content generated based on the candidate formatted text segment 1 is superior to the reply content generated based on the candidate formatted text segment 2, the hyphen connector “−” can be determined as the target connector.

In some embodiments, the plurality of candidate connectors used for replacement may or may not include the connector between two adjacent words in the original text segment, which is not limited herein. Continuing to refer to the above example, that is, the plurality of candidate connectors may further include the space connector “ ”, such that based on the space connector “ ”, the obtained candidate formatted text segment is just the original text segment “The Great Migration in Africa is one of the most spectacular wildlife phenomena in the world”.

It can be understood that the superiority or inferiority of the generated reply content may be determined in any suitable manner and according to any suitable criterion. For example, the superiority or inferiority of the generated corresponding reply content may be determined based on at least one of content quality, timeliness, authority, or relevance to the corresponding query text, which are used for evaluating the corresponding reply content.

For example, the corresponding reply content generated by the large language model based on the candidate formatted text segment 1 and the candidate formatted text segment 2 may be directly obtained. Then, user-input feedback information for the reply content corresponding to each of the candidate formatted text segment 1 and the candidate formatted text segment 2 is received, where the feedback information may be, for example, an operation in which the user clicks on the corresponding reply content to indicate approval of the reply content. Alternatively, other algorithms may be used, for example, performing semantic similarity calculation between the corresponding query instruction and the reply content corresponding to each of the candidate formatted text segment 1 and the candidate formatted text segment 2, to determine the candidate formatted text segment corresponding to the reply content with higher similarity.

Thus, after the target connector is determined from the plurality of candidate connectors, the reply content for replying to the first query instruction can be obtained by using the large language model and based on the first text segment after replacement with the target connector and the first query instruction.

According to some embodiments, determining, from the plurality of candidate connectors by using the large language model and based on the plurality of candidate formatted text segments, the target connector that enables the optimal reply content to be generated, includes: determining the target connector from the plurality of candidate connectors by using the large language model, where for the plurality of candidate connectors, during the generation of corresponding reply content by using the large language model, a target parameter metric determined based on preset output information generated by the large language model from the candidate formatted text segment after replacement with the target connector is optimal.

In the above-mentioned embodiments, the output information is used for representing an attention distribution of the large language model on corresponding input tokens, and the target parameter metric is used for representing a degree to which the attention is uniformly distributed on the corresponding input tokens, where the corresponding input tokens are determined based on a data group formed by the corresponding query instruction and the corresponding text segment and are used as input to the large language model to obtain the corresponding reply content.

Specifically, in the above-mentioned embodiments, for a candidate formatted text segment after replacement with each of the plurality of candidate connectors, the candidate formatted text segment and a corresponding query instruction may be input together into the large language model, to obtain preset output information generated by the large language model during generation of the corresponding reply content, and determine a corresponding target parameter metric based on the preset output information. Then, the candidate formatted text segment corresponding to the preset output information for which target parameter metric is optimal is determined, and the candidate connector in the candidate formatted text segment is taken as the target connector.

In some embodiments, the output information may be any suitable information used for representing an attention distribution of the large language model on corresponding input tokens, for example, an attention vector (e.g., attention weights) corresponding to an intermediate layer or an output layer of the large language model, which is not limited herein.

In some embodiments, the target parameter metric may be any suitable information used for representing the degree to which the attention is uniformly distributed on the corresponding input tokens, such as attention entropy, Gini coefficient, heat map, and bipartite graph, which is not limited herein.

According to some embodiments, quantities of input tokens corresponding to the first query instruction and the second query instruction are approximately the same, where the corresponding input tokens are determined based on a data group formed by the corresponding query instruction and the corresponding text segment and are used as input to the large language model to obtain the corresponding reply content.

In the above-mentioned embodiments, the phrase “approximately the same” means that the information quantities contained in the two are at the same order of magnitude, and have a similar influence on the inference of the model. For example, the phrase “approximately the same” may refer to “the same within a preset range”, and for example, the relative error between the two values is less than a preset threshold. For example, it is assumed that the quantity of corresponding input tokens for the first query instruction is 200, and the quantity of corresponding input tokens for the second query instruction is 220; accordingly, the relative error between them is: (220-200)/max (200, 220)=0.09<0.1, an thus, the quantities of corresponding input tokens for the first query instruction and the second query instruction may be considered approximately the same.

According to some embodiments, obtaining the second query instruction and the second text segment obtained through retrieval based on the second query instruction includes: obtaining a plurality of second query instructions and corresponding second text segments obtained through retrieval based on the plurality of second query instructions.

Thus, further, according to some embodiments, obtaining the plurality of candidate formatted text segments in one-to-one correspondence with the plurality of candidate connectors by replacing at least a part of connectors in the second text segment based on the plurality of candidate connectors includes: obtaining, for each of the plurality of second query instructions, a plurality of candidate formatted text segments corresponding to the second query instruction by replacing at least a part of connectors in the second text segment corresponding to the second query instruction based on the plurality of candidate connectors, where the plurality of candidate formatted text segments corresponding to the second query instruction are in one-to-one correspondence with the plurality of candidate connectors. For a plurality of candidate formatted text segments in one-to-one correspondence with the plurality of second query instructions and after replacement with a same candidate connector, an average value of a plurality of target parameter metrics corresponding to the target connector is optimal, where the plurality of target parameter metrics are in one-to-one correspondence with a plurality of pieces of preset output information generated by the large language model respectively based on the plurality of candidate formatted text segments after replacement with the target connector.

Specifically, in some examples, the quantity of the plurality of second query instructions may be set to a relatively small value, for example, from 5 to 7. As described above, since the first query instruction and the second query instruction may be the same or different, the plurality of second query instructions may or may not include the first query instruction, which is not limited herein.

For example, for two obtained second query instructions, for example, a second query instruction 1 and a second query instruction 2, connectors in the corresponding text segments are replaced using three candidate connectors, thereby obtaining three candidate formatted text segments corresponding to the second query instruction 1, and three candidate formatted text segments corresponding to the second query instruction 2. The three candidate formatted text segments corresponding to the second query instruction 1 are separately input into the large language model together with the second query instruction 1, to obtain three pieces of preset output information corresponding to the three candidate formatted text segments, and calculate three corresponding target parameter metrics; and the same operation is performed for the second query instruction 2, to obtain three pieces of preset output information corresponding to the corresponding three candidate formatted text segments, and calculate three corresponding target parameter metrics. For each of the three candidate connectors, an average value is calculated for the target parameter metric obtained based on the second query instruction 1 and the target parameter metric obtained based on the second query instruction 2 that correspond to the candidate connector. For example, from the three candidate connectors, the candidate connector for which the calculated average value is the highest (that is, the average value of the determined plurality of target parameter metrics is optimal) may be selected as the target connector.

In the above-mentioned embodiments, the provision of the plurality of second query instructions and the corresponding second text segments, and the determination of the target connector based on the optimal average value from the plurality of target parameter metrics may allow randomness to be minimized, ensuring the generalization capability of the selected target connector in subsequent prediction and generation processes.

According to some embodiments, the preset output information is an attention vector corresponding to a last network layer of the large language model when the large language model generates a first token of the reply content.

Generally, the last network layer of the large language model is considered to contain the richest high-level semantic information. Therefore, in some embodiments, forward inference is performed once using the large language model, and an attention vector in the last network layer of the large language model used for predicting the first token of output tokens (that is, the first output token) is extracted. This vector represents the allocation of attention to each token in the input token sequence when the first token is generated. A dimension of the attention vector is the same as a length of tokens input to the large language model. That is, based on the attention of the model on the input token sequence, e.g., x1 . . . xL, the next token x{L+1} is predicted.

In some embodiments, a corresponding target parameter metric can be obtained based on the attention vector. As described above, the target parameter metric is used for representing the degree to which the attention is uniformly distributed on the corresponding input tokens (that is, the input token sequence); that is, the target parameter metric measures whether the attention of the large language model, when predicting the next token, is highly concentrated on a few specific words or is uniformly distributed throughout the context.

For example, the target parameter metric may be entropy, variance, Gini coefficient, or the like, which is not limited herein. In some examples, a higher entropy indicates more dispersed (balanced) attention, and a lower entropy indicates more concentrated attention. A smaller variance indicates more balanced attention distribution. The Gini coefficient is used to measure inequality in distribution; for example, a coefficient closer to 1 indicates that the weights are more concentrated on a few tokens (extremely sparse).

According to some embodiments, the target parameter metric ABS(a) is determined based on the preset output information a through the following operation:

$$ABS ( a ) = 1 - 2 \cdot \vert μ - 0.5 \vert , \qquad Formula ( 1 )$$

$$μ = {\sum }_{t = 1}^{T} ( \frac{t - 1}{T - 1} ) \cdot \frac{{a}_{t}}{{\sum }_{j} {a}_{j}} , \qquad Formula ( 2 )$$

where T represents a quantity of corresponding input tokens, and the corresponding input tokens are determined based on a data group formed by the corresponding query instruction and the corresponding text segment and are used as input to the large language model to obtain the corresponding reply content, and where a dimension of the attention vector a is T, aₜ represents a t^{th} value in the attention vector a, and aⱼ represents a j^{th} value in the attention vector a, with j=1, . . . , T, and t=1, . . . , T.

As described above, the preset output information a may be the attention vector corresponding to the last network layer of the large language model, where the dimension of the vector is T. The target parameter metric ABS(a) calculated according to the above-mentioned embodiments can thus be used to evaluate the degree to which the attention of the large language model is uniformly distributed on the input token sequence. The target parameter metric reaches the maximum score when the attention is uniformly distributed between the two ends of the input token sequence, thereby preventing the model from over-concentrating on the start or the end of the input token sequence. Accordingly, a candidate connector corresponding to the highest target parameter metric value ABS may be selected as the target connector.

In the above-mentioned embodiments where the plurality of second query instructions are obtained, from all candidate connectors, a candidate connector that yields the highest average value of ABS is selected as the final target connector f*, which serves as the format for normalizing the first text segment corresponding to the corresponding first query instruction. That is,

$${f}^{*} = arg {max}_{f} \frac{1}{S} {\sum }_{s = 1}^{S} ( {a}_{s}^{( f )} ) , \qquad Formula ( 3 )$$

where S represents the quantity of the plurality of second query instructions, with s=1, . . . , S, and f represents a corresponding candidate connector of the plurality of candidate connectors.

According to some embodiments, the first text segment and the second text segment are both divided at a granularity of a sentence. Therefore, obtaining the plurality of candidate formatted text segments in one-to-one correspondence with the plurality of candidate connectors by replacing at least a part of connectors in the second text segment includes: determining a preset proportion parameter, where the proportion parameter is used for representing a probability that the preset connector between two adjacent words is replaced with a corresponding candidate connector; and obtaining the plurality of candidate formatted text segments in one-to-one correspondence with the plurality of candidate connectors by replacing the preset connector between two adjacent words in the second text segment based on the plurality of candidate connectors and the proportion parameter.

Specifically, a proportion parameter p can be used to represent a probability that a connector in a text segment is replaced, that is, indicating a proportion of connectors subject to format transformation, or indicating that a proportion 1-p of connectors are not replaced but remain unchanged.

According to the above-mentioned embodiments, the replaced connector and the corresponding replacement proportion that can enhance the robustness and reasoning capability of the system can be further explored, thereby further reducing the sensitivity of the model to the structure of the retrieved content and improving the integration capability of the model for heterogeneous text segments, without altering the semantics.

According to some embodiments, a range of values for the proportion parameter is [0, 1).

Specifically, the proportion parameter p∈[0, 1), that is, p may not be equal to 1 (that is, the connectors may not all be replaced). This is because sentences themselves are segmented based on semantics, and setting p not equal to 1 can reduce the semantic impact introduced by semantic segmentation in preceding operations, thereby achieving fault tolerance.

In the above-mentioned embodiments where the plurality of candidate connectors used for replacement may include a connector between two adjacent words in the original text segment, when the candidate connector is the same as the connector in the original text segment, the proportion parameter corresponding to the candidate connector defaults to 0, that is, indicating that all connectors in the text segment are not replaced. proportion parameters corresponding to the other candidate connectors may be set not equal to 0.

According to some embodiments, the candidate connector used for replacement includes at least one of the following: a space connector, a hyphen connector, an underscore connector, a colon connector, a dot connector, a tilde connector, a plus sign connector, a slash connector, and a connector representing “and”.

It can be understood that the above-mentioned candidate connectors used for replacement are merely exemplary, and any other connectors capable of connecting two adjacent words are possible, which is not limited herein.

In one exemplary embodiment according to the present disclosure, given a user query instruction q and a group of retrieved text segments D={d1, d2, . . . , dm}, a connector format transformation operation may first be performed on each text segment to generate a plurality of candidate formatted text segments. Specifically, by using a predefined set of connectors (such as no connector, hyphen “-”, underscore “_”, colon “:”, dot “.”, tilde “~”, plus sign “+”, slash “/”, and ampersand “&”), intra-sentence reconstruction processing is performed on a part of sentences in the text segment, that is, original connectors (for example, spaces) are replaced with a predefined candidate connector (f) to form a new structured text segment. In this process, the transformation is controlled by the proportion parameter p which represents a proportion of sentences involved in the format transformation. This operation does not alter the semantic content of the sentences but introduces different structural cues at the formal level, thereby generating a plurality of candidate formatted text segments

$${\hat{d}}_{i}^{( f , p )}$$

after formatting for subsequent scoring and selection.

Thus, in order to select the connector most suitable for processing by the current large language model, the above-mentioned attention balance score (ABS) may be employed to quantify the distribution of attention of the model on contextual information under different input formats. Specifically, for each candidate input after formatting, forward inference is performed once by using the target language model, and an attention vector a∈ [symbol] in the last layer of the target language model used for predicting the first token of output tokens is extracted. Based on the distribution of attention along the time dimension, the balance score ABS can be calculated according to Formula (1) and Formula (2). From all candidate formats, a candidate connector that yields the highest average ABS is selected as the final target connector f*, which serves as the format for normalizing the first text segment corresponding to the corresponding first query instruction.

According to some embodiments, before performing the first operation, the method further includes: determining a quantity of input tokens corresponding to the first query instruction, where the input tokens are determined based on a data group formed by the first query instruction and the first text segment and are used as input to the large language model to obtain corresponding reply content; and performing the first operation in response to the absence of a determined target connector corresponding to a quantity of input tokens approximately the same as the quantity of input tokens corresponding to the first query instruction, where the input tokens having approximately the same quantity are determined based on a data group formed by a corresponding second query instruction and a corresponding second text segment obtained through retrieval based on the corresponding second query instruction.

According to some embodiments, the method according to the present disclosure may further include: storing the target connector determined based on the first operation in association with the corresponding quantity of input tokens determined based on the data group formed by the corresponding second query instruction and the corresponding second text segment, in response to the absence of the determined target connector corresponding to the quantity of input tokens approximately the same as the quantity of input tokens corresponding to the first query instruction.

According to some embodiments, generating the reply content for replying to the first query instruction, by using the large language model and based on the first text segment after replacement with the target connector and the first query instruction includes: generating the reply content for replying to the first query instruction, by using the large language model and based on the first text segment after replacement with the determined target connector and the first query instruction, in response to the presence of the determined target connector corresponding to the quantity of input tokens approximately the same as the quantity of input tokens corresponding to the first query instruction.

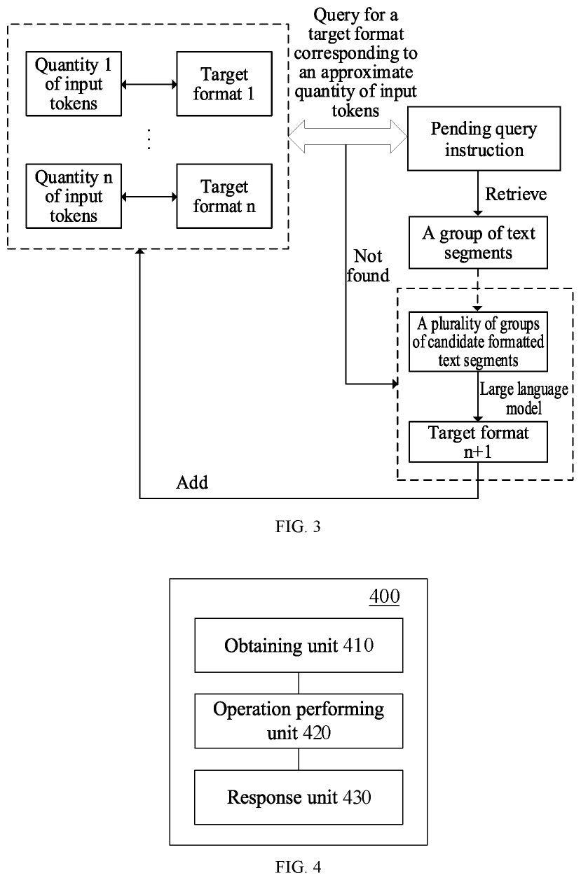

Specifically, as shown in FIG. 3, in some embodiments, after a first query instruction and a first text segment obtained through retrieval based on the first query instruction are obtained, it may first be determined whether a determination operation for a target connector corresponding to another query instruction whose quantity of input tokens is approximately equal has been performed previously. If the determination operation has not been performed, the first operation is performed. If the determination operation has been performed, the determined target connector (that is, a corresponding target format shown in FIG. 3) can be directly reused. That is, connectors in the first text segment obtained through retrieval based on the first query instruction may be replaced by using the above-mentioned determined target connector, thereby obtaining corresponding reply content by using the large language model and based on the first text segment after replacement and the first query instruction.

As described above, if it is determined that the determination operation for a target connector corresponding to another query instruction whose quantity of input tokens is approximately equal has been performed previously, the determined target connector can be directly reused. Therefore, after each execution of the determination operation for the target connector, the determined target connector may be stored in association with its corresponding quantity of input tokens, for subsequent reuse by a corresponding query instruction whose quantity of input tokens is approximately the same.

According to some embodiments, before performing the first operation, the method further includes: determining a quantity of input tokens corresponding to the first query instruction, where the input tokens are determined based on a data group formed by the first query instruction and the first text segment and are used as input to the large language model to obtain corresponding reply content; and performing the first operation in response to the absence of a determined target connector and proportion parameter corresponding to a quantity of input tokens approximately the same as the quantity of input tokens corresponding to the first query instruction, where the input tokens having approximately the same quantity are determined based on a data group formed by a corresponding second query instruction and a corresponding second text segment obtained through retrieval based on the corresponding second query instruction.

According to some embodiments, the method according to the present disclosure may further include: storing the target connector and the proportion parameter determined based on the first operation in association with the corresponding quantity of input tokens determined based on the data group formed by the corresponding second query instruction and the corresponding second text segment, in response to the absence of the determined target connector and proportion parameter corresponding to the quantity of input tokens approximately the same as the quantity of input tokens corresponding to the first query instruction.

According to some embodiments, generating the reply content for replying to the first query instruction, by using the large language model and based on the first text segment after replacement with the target connector and the first query instruction includes: generating the reply content for replying to the first query instruction, by using the large language model and based on the first text segment after replacement with the determined target connector and the first query instruction in response to the presence of the determined target connector and proportion parameter corresponding to the quantity of input tokens approximately the same as the quantity of input tokens corresponding to the first query instruction, where connector replacement is performed on the first text segment based on the determined proportion parameter.

As described above, in some embodiments, after the first query instruction and the first text segment obtained through retrieval based on the first query instruction are obtained, it may first be determined whether a determination operation for a target connector corresponding to another query instruction whose quantity of input tokens is approximately equal has been performed previously. If the determination operation has not been performed, the first operation is performed. If the determination operation has been performed, the determined target connector can be directly reused. In this case, in addition to the determined target connector, a corresponding proportion parameter is also reused. Accordingly, as shown in FIG. 3, the target format may be represented as Target connector+proportion parameter. Then, the connectors in the first text segment obtained through retrieval based on the first query instruction may be replaced by using the above-mentioned determined target connector and the corresponding proportion parameter, thereby obtaining the corresponding reply content by using the large language model and based on the first text segment after replacement and the first query instruction.

Therefore, as described above, after each execution of the determination operation for the target connector, the determined target connector and the corresponding proportion parameter may be stored in association with its corresponding quantity of input tokens, for subsequent reuse by a corresponding query instruction whose quantity of input tokens is approximately the same.

According to the embodiments of the present disclosure, the described method does not involve parameter update and achieves model behavior perception only through lightweight forward propagation. In the formal generation stage, all retrieved text segments will be uniformly subjected to format normalization processing by using the f″ connector, that is, reconstructing the input context based on the selected target connector and proportion parameter and concatenating the reconstructed input context into prompt text as input to the large language model. This normalization operation is performed at the sentence level, thereby ensuring the semantics remain unchanged while unifying the surface structure of the text segments, and thus reducing processing differences caused by format differences.

Finally, the prompt text after the format normalization will be used to generate an answer. Under different tasks, queries, or retrieval results, this normalization mechanism can be reused, having good transferability and universality.

According to the method described in the embodiments of the present disclosure, the proposed contextual normalization method is an input preprocessing mechanism that can directly be applied to large language models (LLMs), and that is primarily used for enhancing the reasoning capability and robustness in long-context retrieval-augmented generation tasks (long-context RAG). The method has high universality and scalability, and can be embedded into existing RAG systems without modifications to the model structure or inference process.

The method according to the embodiments of the present disclosure can be widely applied to various scenarios based on a retrieval-augmented generation framework. For example, open-domain question answering system (open-domain QA): In scenarios such as search engine question answering, intelligent customer service, and general question answering assistants, the system often needs to call a large-scale knowledge base to retrieve a large number of candidate text segments, which are then passed to the large language model for final answer generation. According to the method described in the embodiments of the present disclosure, format standardization can be performed on the retrieved content before the final answer generation, thereby significantly improving the stability of the large language model under conditions of redundancy and disordered sequence of text segments. For example, document-level information extraction and summarization (document-level IE/summarization): During extraction of key information or generation of summaries from long documents (such as policy documents, medical cases, and research papers), the model needs to process a plurality of paragraphs or even multi-document inputs. The normalization of the input format according to the method described in the embodiments of the present disclosure can effectively reduce interference of format noise on comprehension, and improve the information integration capability. For example, multi-turn conversation and intelligent assistant (conversational AI): Intelligent conversation systems often need to retain conversation context and dynamically retrieve supplementary information from external document libraries. In such systems, context and retrieved content are mixed and structurally inconsistent. The normalization of input data according to the method described in the embodiments of the present disclosure improves the context memory consistency and multi-turn tracking capability of the systems. For example, enterprise knowledge question answering and legal compliance assistants (enterprise QA, legal assistants): Enterprise documents, legal clauses, and internal knowledge bases have characteristics such as non-uniform formats and complex content structures. In such scenarios, the method described in the embodiments of the present disclosure can serve as a pre-deployment input standardization component, ensuring stable performance of the large language model during question-answering and generation for knowledge-intensive content.

In some embodiments, the method according to the embodiments of the present disclosure can alternatively serve as an intermediate module embedded into the reasoning chain of any large language model based on retrieval-concatenation-generation, demonstrating strong adaptability.

According to an embodiment of the present disclosure, as shown in FIG. 4, a content generation apparatus 400 based on a large model is further provided. The apparatus includes: an obtaining unit 410 configured to obtain a first query instruction and a first text segment obtained through retrieval based on the first query instruction; an operation performing unit 420 configured to perform a first operation to determine a target connector for replacing a connector used for connecting two adjacent words in the first text segment, the first operation including: obtaining a second query instruction and a second text segment obtained through retrieval based on the second query instruction, where the corresponding text segment is used for generating reply content for replying to the corresponding query instruction; determining a plurality of candidate connectors, where each candidate connector is used for replacing a connector for connecting two adjacent words in the second text segment; obtaining a plurality of candidate formatted text segments in one-to-one correspondence with the plurality of candidate connectors by replacing at least a part of connectors in the second text segment based on the plurality of candidate connectors; and determining, from the plurality of candidate connectors by using the large language model and based on the plurality of candidate formatted text segments, the target connector, a target connector corresponding to a candidate formatted text segment that enables optimal reply content to be generated; and a reply unit 430 configured to generate reply content for replying to the first query instruction, by using the large language model and based on the first text segment after replacement with the target connector and the first query instruction.

Here, the operations of the units 410 to 430 of the content generation apparatus 400 based on a large model are respectively similar to the operations of steps 210 to 230 described above. Details are not described herein again.

In the technical solutions of the present disclosure, collection, storage, use, processing, transmission, provision, disclosure, etc. of user personal information involved all comply with related laws and regulations and are not against the public order and good morals.

According to embodiments of the present disclosure, an electronic device, a readable storage medium, and a computer program product are further provided.

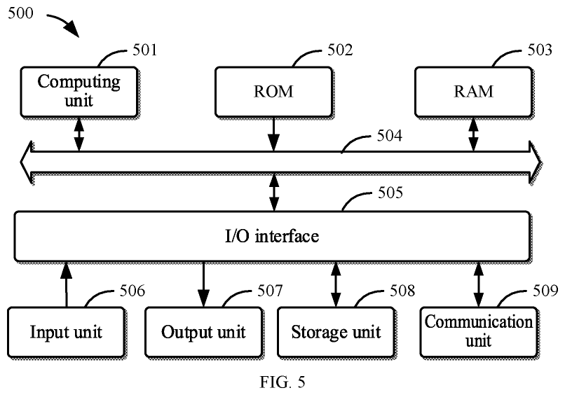

Referring to FIG. 5, a structural block diagram of an electronic device 500 will be described below, which can serve as a server or a client of the present disclosure and is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 5, the electronic device 500 includes a computing unit 501, the computing unit may perform various appropriate actions and processing according to a computer program stored in a read-only memory (ROM) 502 or a computer program loaded from a storage unit 508 to a random access memory (RAM) 503. The RAM 503 may further store various programs and data required for the operation of the electronic device 500. The computing unit 501, the ROM 502, and the RAM 503 are connected to each other through a bus 504. An input/output (I/O) interface 505 is also connected to the bus 504.

A plurality of components in the electronic device 500 are connected to the I/O interface 505, including: an input unit 506, an output unit 507, the storage unit 508, and a communication unit 509. The input unit 506 may be any type of device capable of inputting information to the electronic device 500, the input unit 506 may receive input digit or character information and generate a key signal input related to user settings and/or function control of the electronic device, and may include, but is not limited to, a mouse, a keyboard, a touchscreen, a trackpad, a trackball, a joystick, a microphone, and/or a remote controller. The output unit 507 may be any type of device capable of presenting information, and may include, but is not limited to, a display, a speaker, a video/audio output terminal, a vibrator, and/or a printer. The storage unit 508 may include, but is not limited to, a magnetic disk and an optical disk. The communication unit 509 allows the electronic device 500 to exchange information/data with other devices via a computer network such as the Internet and/or various telecommunication networks, and may include, but is not limited to, a modem, a network interface card, an infrared communication device, a wireless communication transceiver, and/or a chipset, for example, a Bluetooth device, an 802.11 device, a Wi-Fi device, a WiMAX device, and/or a cellular communication device.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units on which machine learning model algorithms run, a digital signal processor (DSP), and any appropriate processor, controller, microcontroller, etc. The computing unit 501 performs the various methods and processing described above, for example, the method 200. For example, in some embodiments, the method 200 may be implemented as a computer software program, which is tangibly contained in a machine-readable medium, such as the storage unit 508. In some embodiments, a part or all of the computer program may be loaded and/or installed onto the electronic device 500 via the ROM 502 and/or the communication unit 509. When the computer program is loaded into the RAM 503 and executed by the computing unit 501, one or more steps of the method 200 described above can be performed. Alternatively, in other embodiments, the computing unit 501 may be configured, by any other appropriate means (for example, by means of firmware), to perform the method 200.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logic device (CPLD), computer hardware, firmware, software, and/or a combination thereof. These various implementations may include implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input means, and at least one output means, and transmit data and instructions to the storage system, the at least one input apparatus, and the at least one output means.

Program codes used to implement the method of the present disclosure can be written in any combination of one or more programming languages. The program code may be provided for a processor or a controller of a general-purpose computer, a special-purpose computer, or other programmable data processing apparatuses, such that when the program code is executed by the processor or the controller, the functions/operations specified in the flowcharts and/or block diagrams are implemented. The program code may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing means (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback); and an input from the user can be received in any form (including an acoustic input, a voice input, or a tactile input).

The systems and technologies described herein can be implemented in a computing system including a backend component (for example, as a data server), in a computing system including a middleware component (for example, an application server), in a computing system including a frontend component (for example, a user computer with a graphical user interface or a web browser through which the user can interact with the implementation of the systems and technologies described herein), or in a computing system including any combination of the backend component, the middleware component, and the frontend component. The components of the system can be connected to each other through digital data communication (for example, a communication network) in any form or medium. Examples of the communication network include: a local area network (LAN), a wide area network (WAN), the Internet, and a blockchain network.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, successively, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely exemplary embodiments or examples, and the scope of the present disclosure is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A content generation method based on a large model, the method comprising:
obtaining a first query instruction and a first text segment obtained through retrieval based on the first query instruction;
performing a first operation to determine a target connector for replacing a connector used for connecting two adjacent words in the first text segment, the first operation comprising:
obtaining a second query instruction and a second text segment obtained through retrieval based on the second query instruction, wherein the first text segment is used for generating reply content for replying to the first query instruction and the second text segment is used for generating reply content for replying to the second query instruction;
determining a plurality of candidate connectors, wherein each candidate connector is used for replacing a connector between two adjacent words in the second text segment;
obtaining a plurality of candidate formatted text segments in one-to-one correspondence with the plurality of candidate connectors by replacing at least a part of connectors in the second text segment based on the plurality of candidate connectors; and
determining, from the plurality of candidate connectors by using the large language model and based on the plurality of candidate formatted text segments, the target connector, a target connector corresponding to a candidate formatted text segment that enables optimal reply content to be generated; and
generating reply content for replying to the first query instruction, by using the large language model and based on the first text segment after replacement with the target connector and the first query instruction.

2. The method according to claim 1, wherein determining, from the plurality of candidate connectors by using the large language model and based on the plurality of candidate formatted text segments, the target connector that enables the optimal reply content to be generated, comprises:
determining the target connector from the plurality of candidate connectors by using the large language model, wherein for the plurality of candidate connectors, during the generation of corresponding reply content by using the large language model, a target parameter metric determined based on preset output information generated by the large language model from the candidate formatted text segment after replacement with the target connector is optimal,
wherein the output information is used for representing an attention distribution of the large language model on corresponding input tokens, and the target parameter metric is used for representing a degree to which the attention is uniformly distributed on the corresponding input tokens, wherein the corresponding input tokens are determined based on a data group formed by the corresponding query instruction and the corresponding text segment and are used as input to the large language model to obtain the corresponding reply content.

3. The method according to claim 1, wherein quantities of input tokens corresponding to the first query instruction and the second query instruction are approximately the same, wherein the corresponding input tokens are determined based on a data group formed by the corresponding query instruction and the corresponding text segment and are used as input to the large language model to obtain the corresponding reply content.

4. The method according to claim 2,
wherein obtaining the second query instruction and the second text segment obtained through retrieval based on the second query instruction comprises: obtaining a plurality of second query instructions and corresponding second text segments obtained through retrieval based on the plurality of second query instructions,
wherein obtaining the plurality of candidate formatted text segments in one-to-one correspondence with the plurality of candidate connectors by replacing at least a part of connectors in the second text segment based on the plurality of candidate connectors comprises: obtaining, for each of the plurality of second query instructions, a plurality of candidate formatted text segments corresponding to the second query instruction by replacing at least a part of connectors in the second text segment corresponding to the second query instruction based on the plurality of candidate connectors, wherein the plurality of candidate formatted text segments corresponding to the second query instruction are in one-to-one correspondence with the plurality of candidate connectors,
and wherein for a plurality of candidate formatted text segments in one-to-one correspondence with the plurality of second query instructions and after replacement with a same candidate connector, an average value of a plurality of target parameter metrics corresponding to the target connector is optimal, wherein the plurality of target parameter metrics are in one-to-one correspondence with a plurality of pieces of preset output information generated by the large language model respectively based on the plurality of candidate formatted text segments after replacement with the target connector.

5. The method according to claim 2, wherein the preset output information is an attention vector corresponding to a last network layer of the large language model when the large language model generates a first token of the reply content.

6. The method according to claim 5, wherein the target parameter metric ABS(a) is determined based on the preset output information a through the following operation:
$$ABS ( a ) = 1 - 2 \cdot \vert μ - 0.5 \vert ,$$
wherein
$$μ = {\sum }_{t = 1}^{T} ( \frac{t - 1}{T - 1} ) \cdot \frac{{a}_{t}}{{\sum }_{j} {a}_{j}} ,$$
wherein T represents a quantity of corresponding input tokens, and the corresponding input tokens are determined based on a data group formed by the corresponding query instruction and the corresponding text segment and are used as input to the large language model to obtain the corresponding reply content, and wherein a dimension of the attention vector a is T, aₜ represents a l^{th} value in the attention vector a, and aⱼ represents a j^{th} value in the attention vector a, with j=1, . . . , T, and t=1, . . . , T.

7. The method according to claim 1, wherein the first text segment and the second text segment are both divided at a granularity of a sentence, wherein obtaining the plurality of candidate formatted text segments in one-to-one correspondence with the plurality of candidate connectors by replacing at least a part of connectors in the second text segment comprises:
determining a preset proportion parameter, wherein the proportion parameter is used for representing a probability that the preset connector between two adjacent words in a corresponding sentence is replaced with a corresponding candidate connector; and
obtaining the plurality of candidate formatted text segments in one-to-one correspondence with the plurality of candidate connectors by replacing the preset connector between two adjacent words in the second text segment based on the plurality of candidate connectors and the proportion parameter.

8. The method according to claim 7, wherein a range of values for the proportion parameter is [0, 1).

9. The method according to claim 1, wherein the candidate connector used for replacement comprises at least one of the following: a space connector, a hyphen connector, an underscore connector, a colon connector, a dot connector, a tilde connector, a plus sign connector, a slash connector, and a connector representing “and”.

10. The method according to claim 1, wherein before performing the first operation, the method further comprises:
determining a quantity of input tokens corresponding to the first query instruction, wherein the input tokens are determined based on a data group formed by the first query instruction and the first text segment and are used as input to the large language model to obtain corresponding reply content; and
performing the first operation in response to the absence of a determined target connector corresponding to a quantity of input tokens approximately the same as the quantity of input tokens corresponding to the first query instruction,
wherein the input tokens having approximately the same quantity are determined based on a data group formed by the corresponding second query instruction and the corresponding second text segment obtained through retrieval based on the corresponding second query instruction.

11. The method according to claim 10, further comprising:
storing the target connector determined based on the first operation in association with the corresponding quantity of input tokens determined based on the data group formed by the corresponding second query instruction and the corresponding second text segment, in response to the absence of the determined target connector corresponding to the quantity of input tokens approximately the same as the quantity of input tokens corresponding to the first query instruction.

12. The method according to claim 10, wherein generating the reply content for replying to the first query instruction, by using the large language model and based on the first text segment after replacement with the target connector and the first query instruction, comprises:
generating the reply content for replying to the first query instruction, by using the large language model and based on the first text segment after replacement with the determined target connector and the first query instruction, in response to the presence of the determined target connector corresponding to the quantity of input tokens approximately the same as the quantity of input tokens corresponding to the first query instruction.

13. The method according to claim 7, wherein before performing the first operation, the method further comprises:
determining a quantity of input tokens corresponding to the first query instruction, wherein the input tokens are determined based on a data group formed by the first query instruction and the first text segment and are used as input to the large language model to obtain corresponding reply content; and
performing the first operation in response to the absence of a determined target connector and proportion parameter corresponding to a quantity of input tokens approximately the same as the quantity of input tokens corresponding to the first query instruction,
wherein the input tokens having approximately the same quantity are determined based on a data group formed by the corresponding second query instruction and the corresponding second text segment obtained through retrieval based on the corresponding second query instruction.

14. The method according to claim 13, further comprising:
storing the target connector and the proportion parameter determined based on the first operation in association with the corresponding quantity of input tokens determined based on the data group formed by the corresponding second query instruction and the corresponding second text segment, in response to the absence of the determined target connector and proportion parameter corresponding to the quantity of input tokens approximately the same as the quantity of input tokens corresponding to the first query instruction.

15. The method according to claim 13, wherein generating the reply content for replying to the first query instruction, by using the large language model and based on the first text segment after replacement with the target connector and the first query instruction, comprises:
generating the reply content for replying to the first query instruction, by using the large language model and based on the first text segment after replacement with the determined target connector and the first query instruction, in response to the presence of the determined target connector and proportion parameter corresponding to the quantity of input tokens approximately the same as the quantity of input tokens corresponding to the first query instruction, wherein connector replacement is performed on the first text segment based on the determined proportion parameter.

16. An electronic device, comprising:
a memory storing one or more programs configured to be executed by one or more processors, the one or more programs including instructions for performing operations comprising:
obtaining a first query instruction and a first text segment obtained through retrieval based on the first query instruction;
performing a first operation to determine a target connector for replacing a connector used for connecting two adjacent words in the first text segment, the first operation comprising:
obtaining a second query instruction and a second text segment obtained through retrieval based on the second query instruction, wherein the first text segment is used for generating reply content for replying to the first query instruction and the second text segment is used for generating reply content for replying to the second query instruction;
determining a plurality of candidate connectors, wherein each candidate connector is used for replacing a connector between two adjacent words in the second text segment;
obtaining a plurality of candidate formatted text segments in one-to-one correspondence with the plurality of candidate connectors by replacing at least a part of connectors in the second text segment based on the plurality of candidate connectors; and
determining, from the plurality of candidate connectors by using the large language model and based on the plurality of candidate formatted text segments, the target connector, a target connector corresponding to a candidate formatted text segment that enables optimal reply content to be generated; and
generating reply content for replying to the first query instruction, by using the large language model and based on the first text segment after replacement with the target connector and the first query instruction.

17. The electronic device according to claim 16, wherein determining, from the plurality of candidate connectors by using the large language model and based on the plurality of candidate formatted text segments, the target connector that enables the optimal reply content to be generated, comprises:
determining the target connector from the plurality of candidate connectors by using the large language model, wherein for the plurality of candidate connectors, during the generation of corresponding reply content by using the large language model, a target parameter metric determined based on preset output information generated by the large language model from the candidate formatted text segment after replacement with the target connector is optimal,
wherein the output information is used for representing an attention distribution of the large language model on corresponding input tokens, and the target parameter metric is used for representing a degree to which the attention is uniformly distributed on the corresponding input tokens, wherein the corresponding input tokens are determined based on a data group formed by the corresponding query instruction and the corresponding text segment and are used as input to the large language model to obtain the corresponding reply content.

18. The electronic device according to claim 16, wherein quantities of input tokens corresponding to the first query instruction and the second query instruction are approximately the same, wherein the corresponding input tokens are determined based on a data group formed by the corresponding query instruction and the corresponding text segment and are used as input to the large language model to obtain the corresponding reply content.

19. The electronic device d according to claim 17, wherein the preset output information is an attention vector corresponding to a last network layer of the large language model when the large language model generates a first token of the reply content.

20. A non-transitory computer-readable storage medium storing computer instructions, wherein the computer instructions are used to cause the computer to perform the following operations:
obtaining a first query instruction and a first text segment obtained through retrieval based on the first query instruction;
performing a first operation to determine a target connector for replacing a connector used for connecting two adjacent words in the first text segment, the first operation comprising:
obtaining a second query instruction and a second text segment obtained through retrieval based on the second query instruction, wherein the first text segment is used for generating reply content for replying to the first query instruction and the second text segment is used for generating reply content for replying to the second query instruction;
determining a plurality of candidate connectors, wherein each candidate connector is used for replacing a connector between two adjacent words in the second text segment;
obtaining a plurality of candidate formatted text segments in one-to-one correspondence with the plurality of candidate connectors by replacing at least a part of connectors in the second text segment based on the plurality of candidate connectors; and
determining, from the plurality of candidate connectors by using the large language model and based on the plurality of candidate formatted text segments, the target connector, a target connector corresponding to a candidate formatted text segment that enables optimal reply content to be generated; and
generating reply content for replying to the first query instruction, by using the large language model and based on the first text segment after replacement with the target connector and the first query instruction.
